(19) United States
(12) Patent Application Publication
(10) Pub. No.: US 2026/0356098 A1
(43) Pub. Date: Nov. 12, 2026

(54) IMAGE FORMING APPARATUS

(71) Applicant: KYOCERA Document Solutions Inc., Osaka (JP)

(72) Inventor: Yamato Kitao, Osaka (JP)

(21) Appl. No.: 19/672,484

(22) Filed: May 8, 2026

(30) Foreign Application Priority Data
May 12, 2025 (JP) 2025-079415

(51) Int. Cl. B41J 2/17; B41J 2/175; B41J 2/21

(52) U.S. Cl. CPC B41J 2/1721; B41J 2/1707; B41J 2/17566; B41J 2/2103

(57) ABSTRACT

Plural waste ink collection containers store waste ink of plural ink colors from flushing of plural inkjet recording heads. A waste ink managing unit (a) performs first notification to prompt replacement of a waste ink collection container among the plural waste ink collection containers when a waste ink amount of the waste ink collection container becomes equal to or larger than a predetermined first threshold value and (b) when the waste ink amount of the waste ink collection container becomes equal to or larger than the predetermined first threshold value, if there is a residual waste ink collection container of which a waste ink amount is equal to or larger than a predetermined second threshold value, performs second notification to prompt replacement of the residual waste ink collection container together with the first notification. Here, the second threshold value is smaller than the first threshold value.

### CROSS-REFERENCE TO RELATED APPLICATIONS

This application relates to and claims priority rights from Japanese Patent Application No. 2025-079415, filed on May 12th, 2025, the entire disclosures of which are hereby incorporated by reference herein.

### BACKGROUND

### 1. Field of the Present Disclosure

The present disclosure relates to an image forming apparatus.

### 2. Description of the Related Art

An inkjet printer includes a first sensor that detects a near-end status of a waste liquid tank, and a second sensor that detects an end status of the waste liquid tank; and when the waste liquid tank becomes in the near-end status, displays a notification that prompts to discard ink in the waste liquid tank, and thereafter, when the waste liquid tank becomes in the end status, prohibits a cleaning operation and displays a warning that prompts to discard ink in the waste liquid tank.

When waste ink discharged by flushing is stored in individual waste ink collection containers respectively for ink colors in a color inkjet image forming apparatus, if one of the waste ink collection containers becomes full, this waste ink collection container is replaced with a new one by a user or the like.

As the aforementioned inkjet printer, if replacement of the waste ink collection container is prompted when the end status is detected individually for any of ink colors, after a user replaces one of the waste ink collection containers of an ink color, another waste ink collection container may be full in a short time and the user may replace this other waste ink collection container; and therefore, replacement operations are required at plural timings in a short term.

### SUMMARY

An image forming apparatus according to an aspect of the present disclosure includes plural inkjet recording heads using ink of plural ink colors, respectively; plural waste ink collection containers; and a waste ink managing unit. The plural waste ink collection containers are configured to store waste ink of the plural ink colors from flushing of the plural inkjet recording heads. The waste ink managing unit is configured to (a) perform first notification to prompt replacement of a waste ink collection container among the plural waste ink collection containers when a waste ink amount of the waste ink collection container becomes equal to or larger than a predetermined first threshold value and (b) when the waste ink amount of the waste ink collection container becomes equal to or larger than the predetermined first threshold value, perform second notification to prompt replacement of a residual waste ink collection container among the plural waste ink collection containers together with the first notification if there is the residual waste ink collection container of which a waste ink amount is equal to or larger than a predetermined second threshold value. Here, the second threshold value is smaller than the first threshold value.

These and other objects, features and advantages of the present disclosure will become more apparent upon reading of the following detailed description along with the accompanied drawings.

### BRIEF DESCRIPTION OF THE DRAWINGS

FIG. 1 shows a side-view diagram that indicates an internal mechanical configuration of an image forming apparatus in an embodiment according to the present disclosure;

FIG. 2 shows a plane-view diagram of the image forming apparatus shown in FIG. 1;

FIG. 3 shows a diagram that indicates an example of a transportation belt 2 shown in FIG. 1;

FIG. 4 shows a top-view diagram that indicates an example of waste ink collecting units 8a, 8b, 8c and 8d in FIG. 1;

FIG. 5 shows a cross-sectional-view diagram that indicates an example of the waste ink collecting units 8a, 8b, 8c and 8d in FIG. 1;

FIG. 6 shows a block diagram that indicates an electronic configuration of the image forming apparatus 10 in the embodiment according to the present disclosure; and

FIG. 7 shows a flowchart that explains a monitoring operation of waste ink collection containers 61a, 61b, 61c and 61d of the image forming apparatus 10 shown in FIGS. 1 - 6.

### DETAILED DESCRIPTION

Hereinafter, an embodiment according to an aspect of the present disclosure will be explained with reference to drawings.

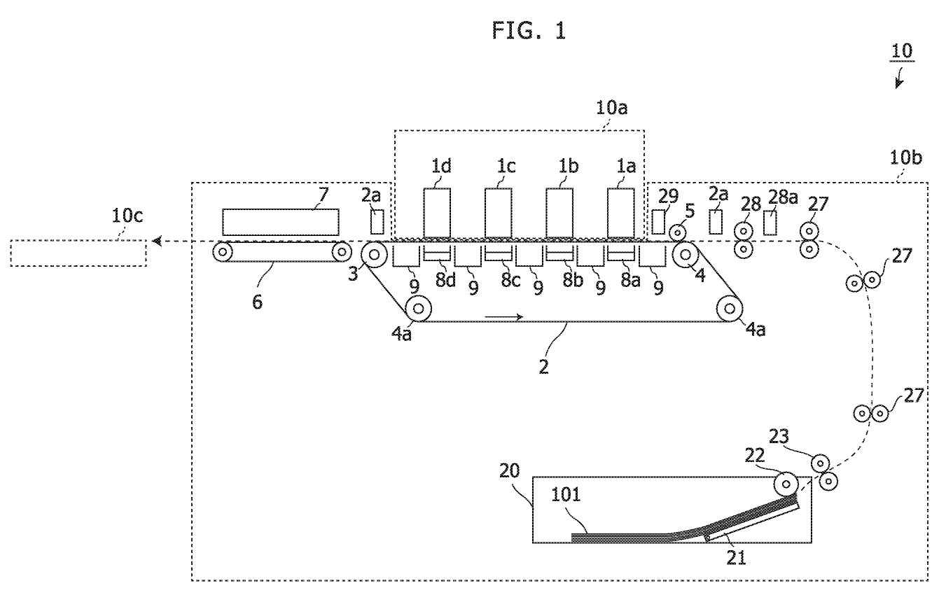

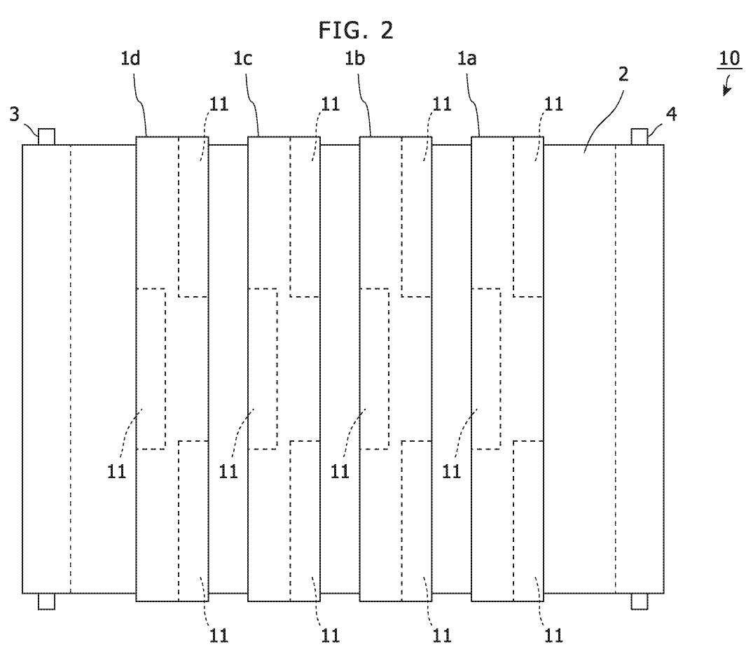

FIG. 1 shows a side-view diagram that indicates an internal mechanical configuration of an image forming apparatus in an embodiment according to the present disclosure. FIG. 2 shows a plane-view diagram of the image forming apparatus shown in FIG. 1. The image forming apparatus 10 in this embodiment is an apparatus such as printer, copier, facsimile machine or multi function peripheral, and includes an inkjet color printing mechanism of a line head type in this embodiment.

The image forming apparatus 10 shown in FIG. 1 includes a print engine 10a and a sheet transportation unit 10b. The print engine 10a physically prints an image to be printed on a print sheet (print paper sheet or the like). An ink cartridge is enabled to be mounted and demounted to and from the print engine 10a, and the print engine 10a performs printing using ink supplied from the ink cartridge. The sheet transportation unit 10b transports to the print engine 10a the print sheet.

In this embodiment, the print engine 10a includes inkjet recording heads 1a to 1d that use ink of plural ink colors (here, four colors: Cyan, Magenta, Yellow and Black), and ejects the ink onto a print sheet using the recording heads 1a to 1d.

As shown in FIG. 2, in this embodiment, each of the inkjet recording units 1a, 1b, 1c and 1d is a line-head-type recording head, and includes one or plural (here, three) head units 11. The head units 11 are arranged along a primary scanning direction, and are capable of being mounted to and demounted from a main body of the image forming apparatus. In the head unit 11, nozzles that eject the ink are 2-dimensionally arranged at equal intervals in a primary scanning direction.

Further, in this embodiment, the sheet transportation unit 10b includes (a) a circular-type transportation belt 2 that is arranged so as to be opposite to the print engine 10a and transports a print sheet, (b) a driving roller 3, a driven roller 4, and a tension roller 4a around which the transportation belt 2 is hitched, (c) a nipping roller 5 that nips the print sheet with the transportation belt 2, (d) a post-stage transportation belt 6, and (e) a dryer 7.

The driving roller 3, the driven roller 4, and the tension roller 4a cause the transportation belt 2 to rotate. The nipping roller 5 nips an incoming print sheet 101 transported from a sheet feeding cassette 20 mentioned below, and the nipped print sheet 101 is transported by the transportation belt 2 to printing positions of the inkjet recording units 1a to 1d in turn, and on the print sheet 101, images of respective colors are printed by the inkjet recording units 1a to 1d. In this situation, the passing print sheet is detected by a sheet sensor 2a, and a current position of the print sheet on a transportation path is determined on the basis of a detection timing by the sheet sensor 2a, and thereby an image is printed at a proper position on the print sheet. Subsequently, the print sheet after printing is outputted by the post-stage transportation belt 6 to an output tray 10c or the like. In this process, the print sheet on which the ink has been ejected is dried by the dryer 7.

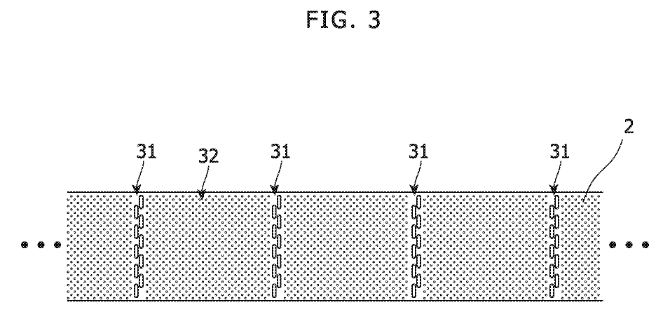

FIG. 3 shows a diagram that indicates an example of a transportation belt 2 shown in FIG. 1. The transportation belt 2 includes a flushing opening part 31. As shown in FIG. 3 for example, a single or plural flushing opening parts 31 is/are formed in the transportation belt 2, and each flushing opening part 31 includes plural opening parts formed along a primary scanning direction. Further, sheet suction holes 32 are substantially uniformly arranged at a predetermined density in an area other than the flushing opening parts 31 of the transportation belt 2.

As shown in FIG. 1 for example, waste ink collecting units 8a to 8d are installed under the recording heads 1a to 1d, respectively. Flushing of nozzles in the recording head 1a, 1b, 1c or 1d (line flushing or the like) is performed when one of the flushing opening parts 31 is located at a position directly under the nozzles, and ink ejected for the flushing is caught and temporarily stored by the corresponding waste ink collecting unit 8a, 8b, 8c or 8d through the flushing opening parts 31 and thereafter, collected to a waste ink collection container.

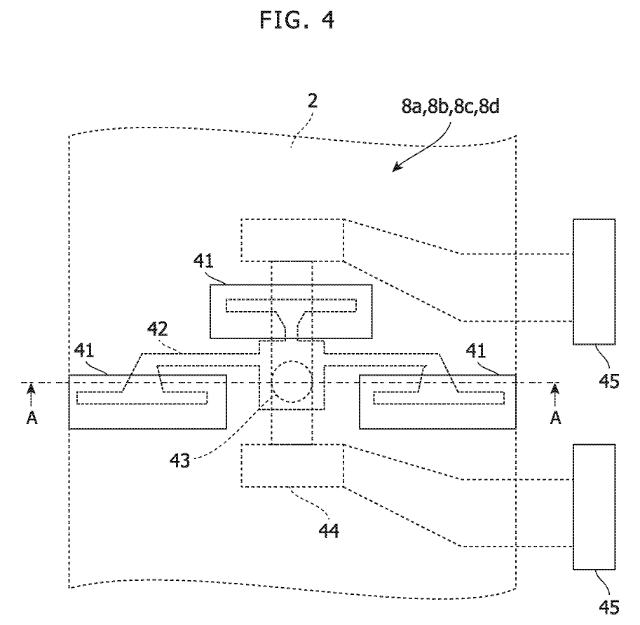

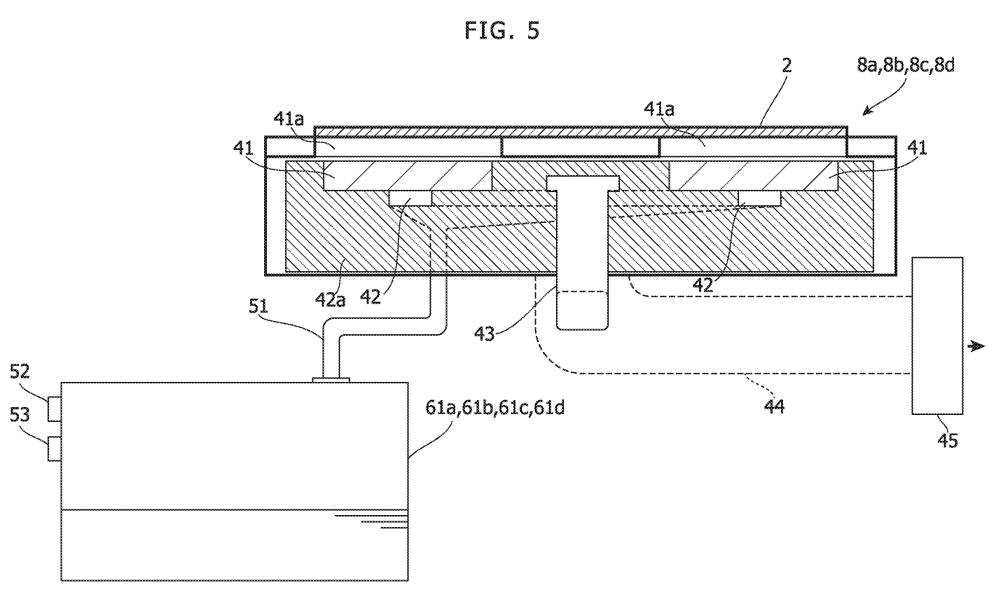

FIG. 4 shows a top-view diagram that indicates an example of waste ink collecting units 8a, 8b, 8c and 8d in FIG. 1. FIG. 5 shows a cross-sectional-view diagram that indicates an example of the waste ink collecting units 8a, 8b, 8c and 8d in FIG. 1. FIG. 5 shows the cross-sectional-view diagram that indicates an A-A cross section in FIG. 4.

As shown in FIG. 4 for example, each of the waste ink collecting units 8a to 8d includes absorption members 41 arranged correspondingly to the head units 11, air flow paths 42, a perpendicular hole 43, an air flow path 44, and a suction fan 45. The absorption member 41 is a sponge or the like, and temporarily stores waste ink from flushing of the recording head 1a, 1b, 1c or 1d. Here, three absorption members 41 are installed correspondingly to the head units 11. The air flow paths 42 are extended from positions under the absorption members 41 to the perpendicular hole 43 individually for the absorption members 41, respectively. The air flow path 44 is extended from the perpendicular hole 43 to the suction fan 45. The perpendicular hole 43 and the air flow path 44 are a common air flow path for the absorption members 41.

Further, as shown in FIG. 5 for example, each of the waste ink collecting units 8a to 8d further includes duct cases 41a arranged between the transportation belt 2 and the absorption members 41. The duct cases 41a, the air flow paths 42, the perpendicular hole 43 and the air flow path 44 are air flow routes extended from the recording heads 1a to 1d to the suction fan 45 through the absorption members 41.

Furthermore, waste ink collection containers 61a, 61b, 61c and 61d are connected to the waste ink collecting units 8a to 8d through waste ink drain paths 51, respectively; and waste ink temporarily stored in the waste ink collecting units 8a to 8d is discharged to the waste ink collection containers 61a, 61b, 61c and 61d through the waste ink drain paths 51, respectively. Consequently, the waste ink collection containers 61a to 61d store waste ink of the corresponding ink colors from flushing of the recording heads 1a to 1d, respectively.

Each of the waste ink collection containers 61a to 61d is detachable and attachable from/to this image forming apparatus, and can be replaced with a new (i.e. empty) ink collection container. Further, the waste ink drain path 51 may be a tube for example, and a pump may be installed in the middle of the waste ink drain path 51 if required.

Returning to FIG. 1, sheet suction units 9 are arranged along the transportation path of the print sheet in a part other than the waste ink collecting units 8a to 8d. A negative pressure is applied to the sheet suction units 9, and thereby the print sheet is adsorbed to the transportation belt 2. It should be noted that a lower negative pressure is applied to the waste ink collecting units 8a to 8d, than that applied to the sheet suction units 9.

Further the sheet transportation unit 10b includes a sheet feeding cassette 20 as a sheet supply source. The sheet feeding cassette 20 stores print sheets 101, and pushes up the print sheets 101 using a lift plate 21 so as to cause the print sheets 101 to contact with a pickup roller 22. The print sheets 101 put on the sheet feeding cassette 20 are picked up to a sheet feeding roller 23 by the pickup roller 22 sheet by sheet from the upper side. The sheet feeding roller 23 is a roller that transports the print sheets 101 sheet by sheet fed by the pickup roller 22 from the sheet feeding cassette 20 onto a transportation path.

A transportation roller 27 is a roller to transport the print sheet 101 on a predetermined transportation path. A registration roller 28 temporarily stops the print sheet 101 when the incoming print sheet 101 in transportation is detected by a registration roller 28a, and transports this print sheet 101 to the print engine 10a (specifically, at a nipping position of the nipping roller 5 and the transportation belt 2) at a secondary sheet feeding timing. The secondary sheet feeding timing is specified by a control unit 81 mentioned below such that an image is formed at a position specified on the print sheet 101.

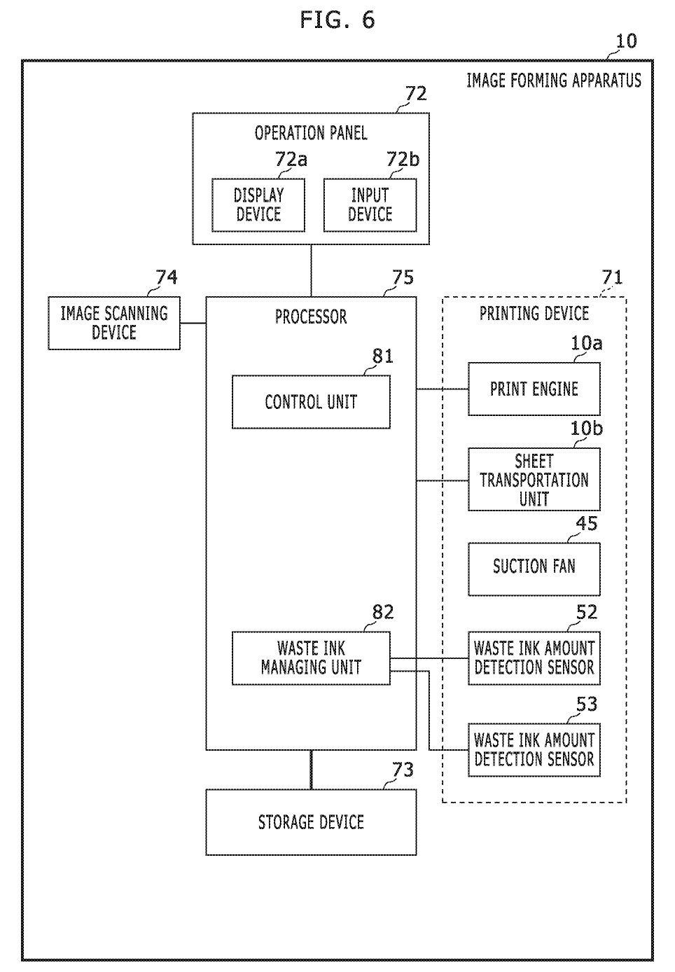

FIG. 6 shows a block diagram that indicates an electronic configuration of the image forming apparatus 10 in the embodiment according to the present disclosure. As shown in FIG. 6, the image forming apparatus 10 includes not only a printing device 71 that includes the mechanical configuration shown in FIGS. 1 - 5 but an operation panel 72, a storage device 73, an image scanning device 74, and a processor 75.

The operation panel 72 is arranged on a housing surface of the image forming apparatus 10, and includes a display device 72a such as a liquid crystal display and an input device 72b such as a hard key and/or a touch panel, and displays sorts of messages for a user using the display device 72a and receives a user operation using the input device 72b.

The storage device 73 is a non-volatile storage device (flash memory, hard disk drive or the like) in which data, a program and the like have been stored that are required for control of the image forming apparatus 10.

The image scanning device 74 includes a platen glass and an auto document feeder, and optically scans a document image from a document put on the platen glass or a document fed by the auto document feeder, and generates image data of the document image.

The processor 75 includes a computer that acts in accordance with a program, an ASIC (Application Specific Integrated Circuit) that performs a predetermined action, and/or the like, and acts as sorts of processing units using the computer, the ASIC and/or the like. This computer includes a CPU (Central Processing Unit), a ROM (Read Only Memory), a RAM (Random Access Memory) and the like, and loads a program stored in the storage device 73, the ROM or the like to the RAM and executes the program using the CPU and thereby acts as processing units (with the ASIC if required).

Here, the processor 75 includes a control unit 81, and a waste ink managing unit 82.

The control unit 81 controls the printing device 71 (the print engine 10a, the sheet transportation unit 10b and the like), and thereby performs a print job requested by a user. In this embodiment, the control unit 81 performs a predetermined image process if required, and controls the print engine 10a (the head units 11) and causes the head units 11 to eject ink and thereby forms a print image on a print sheet.

The control unit 81 causes the printing device 71 to print an image specified by a user. Specifically, the control unit 81 causes the print engine 10a to print a user document image based on printing image data specified by a user.

The control unit 81 causes the print engine 10a to eject ink when printing the user document image, and also causes the print engine 10a to eject ink at predetermined flushing timings. In this manner, at predetermined flushing timings, the print engine 10a repeatedly performs flushing of ink to the flushing opening parts 31. This flushing is performed for discarding ink thickened in the head nozzle.

The waste ink managing unit 82 performs first notification to prompt replacement of a waste ink collection container among the plural waste ink collection containers 61a to 61d when a waste ink amount of the waste ink collection container 61i becomes equal to or larger than a predetermined first threshold value; and when the waste ink amount of the waste ink collection container 61i becomes equal to or larger than the predetermined first threshold value, if among the plural waste ink collection containers 61a to 61d there is a residual waste ink collection container of which a waste ink amount is equal to or larger than a predetermined second threshold value, the waste ink managing unit 82 performs second notification to prompt replacement of the residual waste ink collection container together with the first notification. This second threshold value is set to be smaller than the aforementioned first threshold value. Here, the notification is performed as displaying a message on the display device 72a to prompt replacement of the waste ink collection container.

In this embodiment, the waste ink managing unit 82 determines a waste ink emission amount per day from flushing of each of the recording heads 1a to 1d, and the second threshold value is a value obtained by subtracting this waste ink emission amount per day from the first threshold value.

The waste ink emission amount per day may be determined on the basis of ink ejection amounts for flushing and the number of flushing times per day, and may be an average value in a predetermined period (e.g. one week).

Here, the first threshold value is a waste ink storage upperlimit value of each of the waste ink collection containers 61a to 61d, and the first threshold values for the waste ink collection containers 61a to 61d may be same as each other or may be different from each other.

Furthermore, in this embodiment, waste ink amount detection sensors 52 and 53 are installed to each of the plural waste ink collection containers 61a to 61d. The waste ink amount detection sensors 52 and 53 may be fixed to the image forming apparatus 10 or may be fixed to the waste ink collection container 61a, 61b, 61c or 61d. The waste ink amount detection sensor 52 individually detects that the waste ink amount of each of the waste ink collection containers 61a to 61d becomes equal to or larger than the first threshold value, respectively; and the waste ink amount detection sensor 53 individually detects the waste ink amount of each of the waste ink collection containers 61a to 61d becomes equal to or larger than the second threshold value.

For example, the waste ink amount detection sensors 52 and 53 are optical sensors or capacitive sensors that detect that a liquid level of the waste ink becomes equal to or higher than a predetermined height.

Further, without installation of the waste ink amount detection sensors 52 and 53, the waste ink managing unit 82 may count an ink ejection amount for flushing and may detect that a waste ink amount of the waste ink collection container becomes the first threshold value or the second threshold value on the basis of a counted value of the ink ejection amount.

The following part explains a behavior of the image forming apparatus 10.

When a user requests, the control unit 81 controls the print engine 10a and the sheet transportation unit 10b and thereby performs printing of an image specified by the user. When printing the image, the control unit 81 controls the print engine 10a, and causes to eject ink from a nozzle in the recording heads 1a to 1d at an ink ejection timing for a pixel for which ink should be ejected in the image.

Further, when a user requests or at a predetermined timing, the control unit 81 performs flushing (line flushing or the like) of the recording heads 1a to 1d. Here, the control unit 81 causes to eject ink from a nozzle in the recording heads 1a to 1d toward the flushing opening part 31. The ink ejected in the flushing is collected and temporarily stored by the absorption member 41 through the flushing opening part 31 and the duct case 41a, and thereafter, discharged to the waste ink collection container 61a, 61b, 61c or 61d.

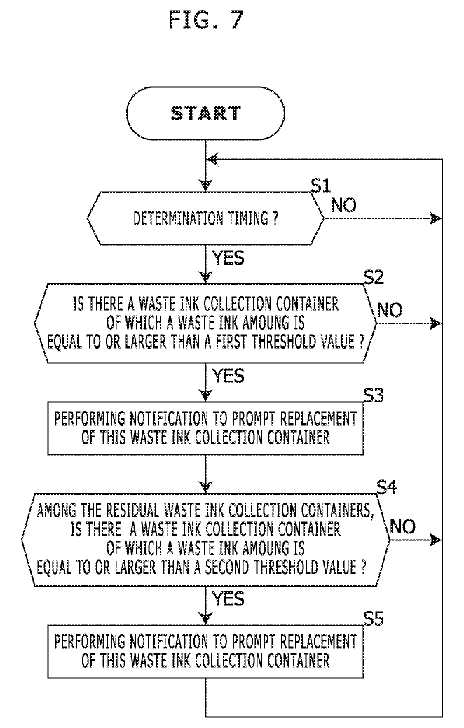

Here, explained is the notification to prompt replacement of the waste ink collection container 61a, 61b, 61c or 61d. FIG. 7 shows a flowchart that explains a monitoring operation of waste ink collection containers 61a, 61b, 61c and 61d of the image forming apparatus 10 shown in FIGS. 1 - 6.

When detecting a predetermined determination timing (in Step S1), the waste ink managing unit 82 performs a following process. Here, the determination timing may be a flushing completion time point or all time points (i.e. always).

When detecting a predetermined determination timing, the waste ink managing unit 82 determines whether a waste ink amount of the stored waste ink is equal to or larger than the first threshold value or not for each of the waste ink collection containers 61a to 61d, and whether there is at least one waste ink collection container of which the waste ink amount is equal to or larger than the first threshold value or not (in Step S2).

If there are no waste ink collection containers of which the waste ink amount is equal to or larger than the first threshold value, then the waste ink managing unit 82 does not perform the aforementioned notification and returns to Step S1.

Contrarily, if there is at least one waste ink collection container of which the waste ink amount is equal to or larger than the first threshold value, then the waste ink managing unit 82 performs the (first) notification to prompt replacement of the waste ink collection container of which the waste ink amount is equal to or larger than the first threshold value (in Step S3), and further determines whether a waste ink amount of the stored waste ink is equal to or larger than the second threshold value or not for each of the residual waste ink collection containers (in Step S4); and if there is at least one residual waste ink collection container of which the waste ink amount is equal to or larger than the second threshold value, then the waste ink managing unit 82 performs the (second) notification to prompt replacement of the waste ink collection container of which the waste ink amount is equal to or larger than the second threshold value together with the first notification (in Step S5). For example, ink colors of the plural waste ink collection containers to be replaced, determined in Steps S2 and S4 are displayed together with each other.

Here, in Step S4, if there are no waste ink collection containers of which the waste ink amount is equal to or larger than the second threshold value among the residual waste ink collection containers, then the aforementioned notification is performed for only the waste ink collection container detected in Step S2 among the waste ink collection containers 61a to 61d.

For example, if the waste ink collection container determined in Step S2 has not been replaced yet, then the aforementioned notification may be performed continuously until this waste ink collection container is replaced.

For example, if the waste ink collection container determined in Step S4 has not been replaced yet although the waste ink collection container determined in Step S2 has been replaced, then the aforementioned notification may be performed continuously until the waste ink collection container determined in Step S4 is replaced, and alternatively, the notification for the waste ink collection container determined in Step S4 may be not performed until a waste ink amount of a waste ink collection container becomes equal to or larger than the first threshold value and the aforementioned notification is performed for this waste ink collection container.

As mentioned, in the aforementioned embodiment, the waste ink collection containers 61a to 61d store waste ink of corresponding ink colors from flushing of the recording heads 1a to 1d, respectively. When a waste ink amount of the waste ink collection container 61i becomes equal to or larger than a predetermined first threshold value, the waste ink managing unit 82 (a) performs first notification to prompt replacement of a waste ink collection container among 61i the plural waste ink collection containers 61a to 61d; and (b) if there is a residual waste ink collection container of which a waste ink amount is equal to or larger than a predetermined second threshold value, performs second notification to prompt replacement of the residual waste ink collection container together with the first notification. Here, the second threshold value is set to be smaller than the first threshold value.

Consequently, when a waste ink collection container is replaced, replacement of another waste ink collection container tends to be performed together, and therefore, restrained is burden of replacement operations manually performed for the waste ink collection container by a user.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. An image forming apparatus, comprising:
plural inkjet recording heads using ink of plural ink colors, respectively;
plural waste ink collection containers configured to store waste ink of the plural ink colors from flushing of the plural inkjet recording heads; and
a waste ink managing unit configured to (a) perform first notification to prompt replacement of a waste ink collection container among the plural waste ink collection containers when a waste ink amount of the waste ink collection container becomes equal to or larger than a predetermined first threshold value and (b) when the waste ink amount of the waste ink collection container becomes equal to or larger than the predetermined first threshold value, perform second notification to prompt replacement of a residual waste ink collection container among the plural waste ink collection containers together with the first notification if there is the residual waste ink collection container of which a waste ink amount is equal to or larger than a predetermined second threshold value;
wherein the second threshold value is smaller than the first threshold value.

2. The image forming apparatus according to claim 1, wherein the waste ink managing unit determines a waste ink emission amount per day from flushing of the recording head; and
the second threshold value is a value obtained by subtracting the waste ink emission amount per day from the first threshold value.

3. The image forming apparatus according to claim 1, wherein the first threshold value is a waste ink storage upperlimit value of the waste ink collection container.

4. The image forming apparatus according to claim 1, further comprising first sensors installed to the plural waste ink collection containers, respectively, and second sensors installed to the plural waste ink collection containers, respectively;
wherein the each of first sensors individually detects that the waste ink amount becomes equal to or larger than the first threshold value; and
each of the second sensors individually detects that the waste ink amount becomes equal to or larger than the second threshold value.
